(19) United States
(12) Patent Application Publication
(10) Pub. No.: US 2006/0136622 A1
(43) Pub. Date: Jun. 22, 2006

(54) Modular controller apparatus and method

(75) Inventors: Thierry R. Rouvelin, Goodrich, MI (US); Daryl Beesley, South Lyon, MI (US); Lawrence E. Piggins, Dublin, CA (US); Michael L. Ritchey, Grand Blanc, MI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX Corporation

(21) Appl. No.: 11/016,754

(22) Filed: Dec. 21, 2004

(51) Int. Cl. G06F 13/38

(52) U.S. Cl. 710/62

(57) ABSTRACT

A servomotor controller provides nut runner and other functions in a set of stackable modules. Extended-function modules can be added into and removed from the stack as needed. Destacking of closely spaced, wall-mounted controllers can be performed without demounting. Module assemblies are dripproof. Multiple sizes of nutrunner driver electronics and multiple keyboard and display options can be selected. A reprogrammable central processor can identify newly installed or removed features within a controller and reconfigure itself F accordingly. Stackable modules include Ethernet(®, multiple-bit I/O, and proprietary interfaces for many industries. The other modules communicate with the processor module via a backplaneless bus architecture. The central processor supports master/satellite group operation, whereby one controller unit can command multiple others, and whereby a higher-level system can command multiple controllers or multiple master/satellite controller groups.

### FIELD OF THE INVENTION

The present invention relates generally to electronic apparatus modularization. More particularly, the present invention relates to stackable electronic modules for customizable servomotor controller configuration.

### BACKGROUND OF THE INVENTION

Existing servomotor controller products are used for many purposes, including providing precisely controlled power to fastening tools known in the art as nutrunners. Servomotor controller products are presented in a variety of packaging configurations, as determined by such factors as operational requirements, marketing strategies, and cost considerations. For example, some servomotor controllers are offered by manufacturers as standalone entities with fixed envelope sizes and fixed lists of features. Other servomotor controller products are offered with multiple levels of capability; for these products, it is common to provide a fixed package size and a customizable list of features, with capabilities and options, including upgrades, typically factory installed.

While the above configurations and others are known and accepted in the marketplace, they retain drawbacks. Among these is the drawback that a controller receiving an upgrade is likely to be unavailable for use during an installation period. Other drawbacks include the risk that an error in the upgrade process may cause protracted loss of use, and that a warranty or calibration certification may be voided by the work. Another drawback is the likelihood that an upgrade, once installed in one unit, is seldom removed and installed in a different unit, so that upgrades are often effectively permanent. This can lead to hesitation to acquire added capabilities for individual controllers, particularly if an added capability is needed in a particular controller for a short term.

The expense of having the upgrade performed is in some cases increased by the cost of shipping and the risk of hidden damage taking place during shipping.

Servicing of servomotor controllers is likewise affected by the unitized construction typical of controllers. Component swapping as a troubleshooting method is slowed by the often closely configured envelope size. Modularization by function within a controller is not assured, so that good components may be replaced along with faulty ones. This can lead to increases in the cost of replaced components as well as in time and labor expended.

Accordingly, it is desirable to provide a method and apparatus that allow an electronic servomotor controller or related device to be reconfigured repeatedly without disassembly of an enclosed chassis and without the associated risks of loss of use or added incurred cost. It is further desirable to facilitate maintenance by enhancing modularization and by simplifying repair procedures.

### SUMMARY OF THE INVENTION

The foregoing needs are met, to a great extent, by the present invention, wherein in one aspect an apparatus is provided that in some embodiments stacks a number of functional units, using a stacking-connector-based system bus for communication between units. Typical functional units can include displays, controls, and other operator interface elements, communication links to standard external devices, premises power access and conditioning, and servomotor controller functions sufficient to establish a useful standalone product. Functional units in some embodiments are capable of performing inquiries by way of the system bus to determine if additional units are presently installed and of adjusting display information and control functionality to integrate add-on units.

In accordance with one embodiment of the present invention, a modular expandable controller is presented. The modular expandable controller includes a drive module having connectors configured to provide connections to a tool, a first housing containing at least in part the drive module, a controller module in communication with the drive module and configured to send a control signal to the drive module, and a second housing containing at least in part the controller module.

In accordance with another embodiment of the present invention, a modular expandable controller is presented. The modular expandable controller includes modular driving means having connectors configured to provide connections to a tool, first housing means containing at least in part the driving means, modular controlling means in communication with the driving means and configured to send a control signal to the driving means, and second housing means containing at least in part the controlling means.

In accordance with yet another embodiment of the present invention, a method of assembling a modular controller is presented. The method of assembling a modular controller includes configuring a first function performed by a controller, implemented using electronic devices, encased in a first housing to form a module, configuring a second function performed by a controller, implemented using electronic devices, encased in a second housing to form a module, and mechanically and electronically connecting the modules together.

There have thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as in the abstract, are used for the purpose of description and should not be regarded as limiting.

As such, those skilled in the art will appreciate that the conception upon which this disclosure is based may readily be used as a basis for the design of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an exploded perspective view illustrating servomotor controller modules according to an embodiment of the invention.

FIG. 2 is a block diagram of a modular servomotor controller including multiple modules, and further showing internal functional blocks, intermodule connectors, and external interface connectors for the controller.

FIG. 3 is a perspective view showing modules partially separated.

FIG. 4 is an enlarged view of a hinge mechanism in accordance with the invention.

FIG. 5 is a section view of a joined latch between generic modules.

FIG. 6 is a section view of a joined latch between a controller module and a Servo module.

### DETAILED DESCRIPTION

The invention will now be described with reference to the drawing figures, in which like reference numerals refer to like parts throughout. An embodiment in accordance with the present invention provides a modular servomotor controller electronics stack that permits functionality embodied in electronic devices housed within one or more stackable modules to be augmented by connecting additional modules. In other words, the controller can be given additional capabilities and features by adding modules. Some embodiments of the invention use a stacking connector system rather than a separate backplane to interconnect the functional modules.

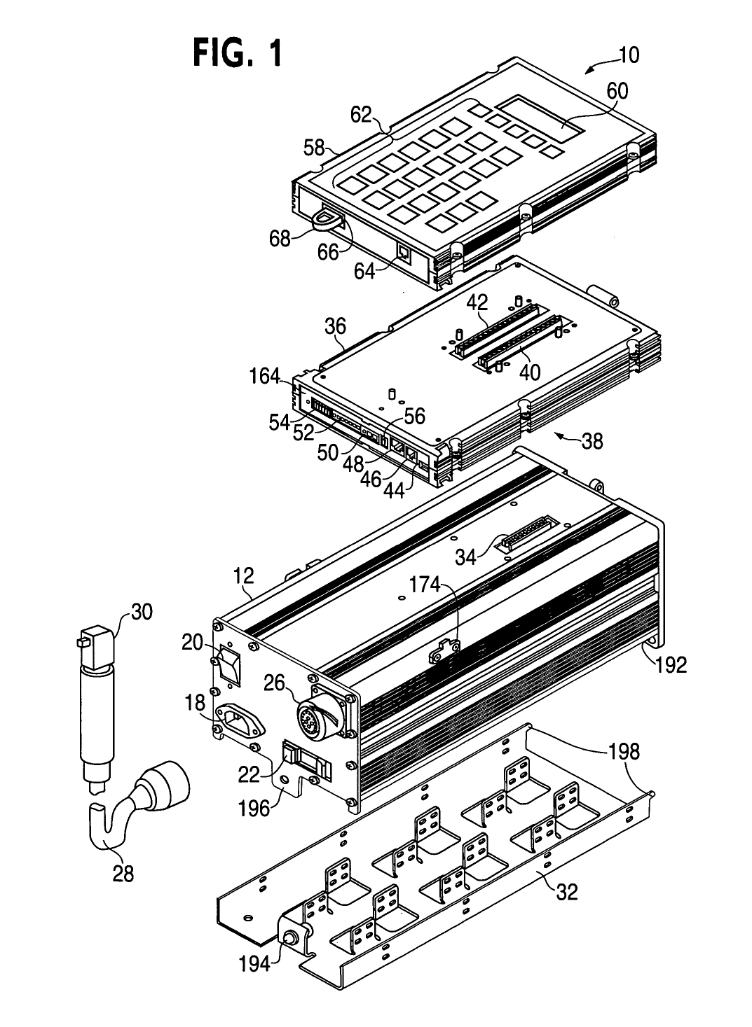

FIG. 1 is an exploded perspective view of a servomotor controller 10, assembled from representative set of modules, namely a User interface module 58, a Control Module 36, and a Servo module 12, provided with a mounting base 32.

The modules in this embodiment perform a series of functions associated with the features visible in this view. For example, the bottommost module in FIG. 1, which is the Servo module 12, is shown with a power input port 18. Interfaces to the Servo module 12 may further include a power switch 20, a protective device 22 such as a fuse, circuit breaker, or ground fault interruptor (GFI), and, in some embodiments, features such as premises voltage selection. There is further provision for a Servo Motor Controller (SMC) connecting cable socket 26, where the SMC cable socket 26 allows connection to an SMC cable 28 terminated at a nutrunner 30.

The Servo module 12 also provides a stacking interface connector 34. In the embodiment shown, the Servo module interface connector 34 is a 48-pin female Deutsche Industrie Norm (DIN) standard connector, which is one of several connector styles suitable for such applications; alternatives may be used in some embodiments.

The Servo module 12 shown has a power driver circuit to actuate nutrunner devices 30 in a particular power range. When the controller 10 is to be applied to nutrunners 30 in other power ranges, the Servo module 12 can be removed and a substitute Servo module 12 better suited to the power range can be installed in its place.

The Servo module 12 shown is in some embodiments further provided with provision for mounting. Where mounting is used, the servomotor controller 10 can be attached to a vertical surface, so that the connectors are oriented downward, reducing exposure to contamination by fluids and particulates.

For clarity, the invention is presented in the drawings with the mounting bracket 32 down. Terms such as “top” and “bottom” used herein refer to this orientation. However, in many installations, the “bottom” surface as shown herein would preferably be mounted to a wall or other vertical surface, with the module edges into which external cables are plugged pointing downward. This orientation can permit multiple controllers to be mounted in close quarters, can allow displays to be viewed readily, and can ease sealing and strain relief requirements on cables and connectors.

It is further understood that the term “stack” refers to connecting modules 58, 36, and 12 together as described. Actual stacking of modules 58, 36, and 12 one on top of another of course only occurs when the controller 10 is in an attitude such as that shown in FIG. 1. When the controller 10 is oriented to other positions, such as being rotated 90 degrees for wall mounting, the modules 58, 36, and 12 can still be connected to each other, but are not necessarily mounted one on top of another.

Where a Servo module 12 is attached to a wall, the attachment may be direct, such as by provision of mounting ears on the Servo module 12 housing permitting application of bolts or the like, or may use an arrangement that can simplify installation and removal, such as a mounting base 32 as shown in FIG. 1. The mounting base 32 is configured to attach to a wall, as by bolting, and has hanging fingers 198 mateable with holes 192 in the Servo module 12. The mounting base 32 further has a detent pin 194 over which a detent capture clip 196 on the Servo module 12 fits to provide positive retention. Other configurations are likewise possible in accordance with the invention. The configuration shown provides suspension of the servomotor controller 10, both when properly clipped to the detent pin 194 and otherwise, preferably reducing risk of dropping and attendant damage.

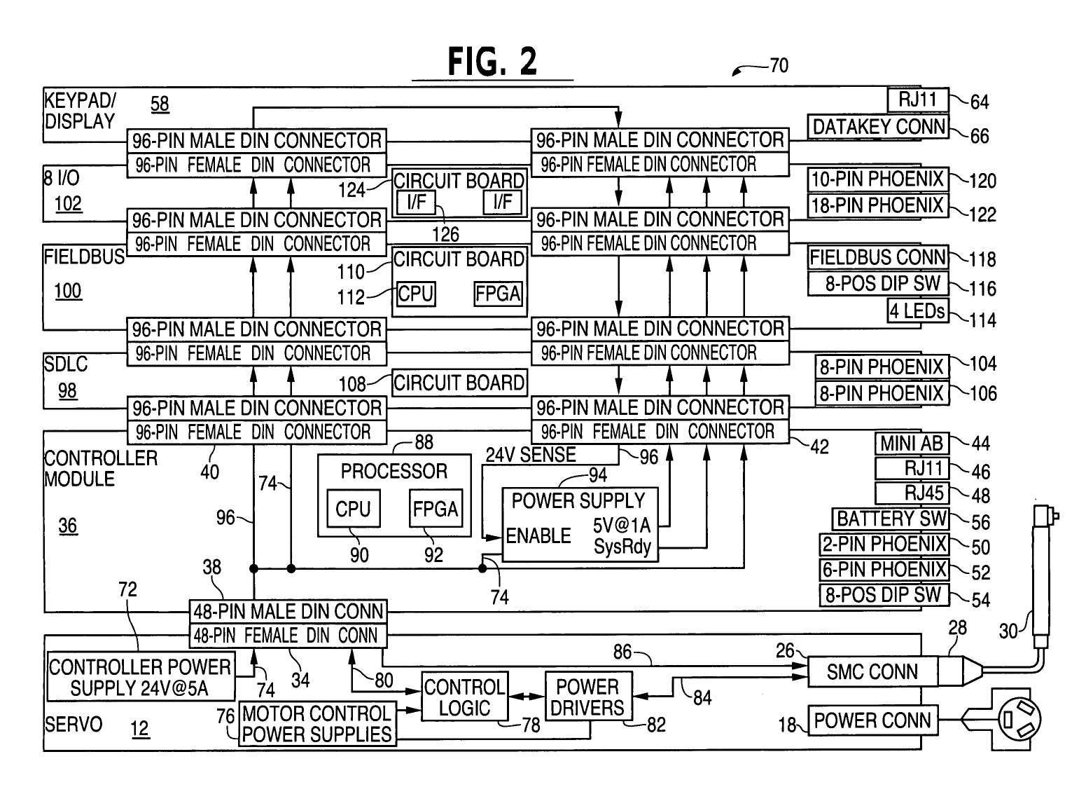

Into the Servo module 12 in the embodiment shown is plugged a Controller Module 36. Electrical connection between the Servo module 12 and the controller module 36 is realized with mating 48-pin DIN connectors, of which the female 34 is visible in FIG. 1, and the male 38 is shown schematically in FIG. 2. The controller module 36 in the embodiment shown has bus connectors on its top surface that allow the controller module 36 to serve as the lowest module of an add-on-capable stack of control and support modules. The controller module top surface bus connectors in the embodiment shown are a first bus connector 40 and a second bus connector 42, both of which, in the embodiment shown, are 96-pin DIN shells populated with female contacts (receptacles).

The controller module 36 shown in FIG. 1 includes additional connectors and features. These include a universal serial bus (USB)-compatible connector 44 that can drive at least a dedicated printer, and in some embodiments provides connectivity for configuring the servomotor controller 10 as a satellite unit. An RJ-11 (modular telephone style, configured as a serial port compliant with Electrical Industry Association (EIA) successor International Electrotechnical Commission (IEC) Recommended Standard (RS) IEC-232) connector 46 supports a variety of input/output functions such as printers, barcode scanners, transducers, and the like. An RJ-45 (Ethernet® 10/100baseT style) connector 48 is used in the controller module 36 for interface to a variety of proprietary communications protocols, such as Visual Supervisor®, the DiamlerChrysler Plant Floor Communication System (PFCS), and equivalent signals for General Motors (GM), Ford, and other manufacturers' proprietary communication systems. A two-pin proprietary connector 50 provides backup power to the controller module 36. The final connector shown in the controller module 36 embodiment is a 6-pin rectangular connector 52 of a proprietary style, which connector supports a proprietary bus, and may be used to connect the controller module 36 to selected external I/O devices with pin and protocol assignments supporting the proprietary bus.

In addition to connectors, the embodiment shown includes switches, such as a multiple-position dual-inline-package (DIP) switch 54 that allows parameters to be selected by hand where automated detection may be ineffective or inconvenient, such as selection between PFCS and other proprietary communication protocols and the like, and a switch 56 enabling battery backup of clock and static memory functions.

FIG. 1 further shows a Keypad/Display module 58 embodiment that sits atop a module stack. Most styles of Keypad/Display module 58 can provide at least minimal user interface, such as a torque readout display 60, a keypad 62 for local input such as controlling the application of a nutrunner 30 to a load, and the like. Embodiments of a Keypad/Display module 58 that support added autonomy for a servomotor controller 10 can include numeric readouts or lamps showing additional information, keypads of varying complexity, such as to allow direct parameter entry, display panels for text and graphics in place of numeric readouts, and the like. Where no user interface is required at a controller 10, a blank panel may be used.

Any Keypad/Display module 58, whether blank or not, may have additional connectors. Typical connectors for a Keypad/Display module 58 include an RJ-11 connector 64 (again configured as an IEC-232 serial port) to provide a detachable interface to a Visual Supervisor® master or another master control interface, and a Datakey® connector 66 (shown with a Datakey® 68 device inserted) for input of configuration or parameter information. Other or additional connector styles and functions may be used for some Keypad/Display module 58 embodiments.

FIG. 2 shows a block diagram 70 of a modular servomotor controller into which functional modules in addition to those described above have been integrated. Typical connectors of the types listed above are shown in this diagram, as well as internal elements of the modules.

Viewing again from the lowest module, the Servo module 12 accepts input power 18, converts it using an AC/DC power supply 72, and furnishes the power 74 to the 48-pin DIN interface connector 34. The Servo module 12 further includes a motor controller power supply 76 and appropriate control logic 78, likewise interfaced 80 to the 48-pin DIN connector 34, and allowing the Servo module 12 to operate an output driver 82 that provides 84 power to drive the external nutrunner 30. A typical nutrunner 30 has “smart” feedback that not only operates in closed loop mode but can also provide some in-device storage and processing of information, including digitization. The telemetry from the nutrunner 30 is shown fed back 86 to the 48-pin DIN connector 34. Additional functions of the Servo module 12 may include self-status monitoring such as temperature sensing on heat sinks in the power supply 76 and output driver 82.

The controller module 36 embodiment shown includes a microprocessor-based controller 88 that accepts multiple inputs and provides output command signals to the output driver 82 in the Servo module 12 via the mating 48-pin DIN connector 38. It is to be understood that the microprocessor-based controller 88 referred to herein may include at least one off-the-shelf monolithic integrated circuit microprocessor device 90 functioning as a master. The controller may be realized using, instead of or in addition to monolithic processor technology, any of a variety of other technologies. Among available technologies is the embedment of an intellectual property (IP) processor core, other IP entities, storage registers, glue logic, analog functions, and the like, into programmable logic devices (PLDs) using such technologies as field-programmable gate arrays (FPGAs). Functionality within the controller module controller 88 may be partitioned in some embodiments, so that, for example, bus interface, communication, display, and the like are controlled by a monolithic processor 90, while the nutrunner driver is controlled by an embedded processor core within an FPGA 92.

The controller module 36 can include interfaces to substantially all of the pins in the Servo module connector 38 and the first and second bus connectors 40 and 42, respectively, by means of access portals such as FPGA 92 pins. Use of appropriately chosen FPGA 92 devices as interfaces can allow some signal lines in the bus connectors 40 and 42 to be unassigned at the time of manufacture of the controller module 36 but to accept reprogramming without need to perform any mechanical disassembly. Some FPGA devices allow reprogramming after installation, allowing interface pins to be activated as, for example input-only, output-only, or bidirectional ports, and can include high impedance options that support bus sharing. FPGA devices in many cases support extensive logic and memory functionality in addition to bus interface and physical-layer port connectivity. Standard functions, such as bus and port interfaces, parallel-to-serial converters, digital comparators, and the like can be compiled into images and downloaded into previously installed FPGA devices.

The controller module 36 is further shown to include a power supply 94 that accepts 24 VDC power 74 from the Servo module 12 and provides regulated power required by other modules on the bus. An additional source of power is provided in some embodiments by connecting the 24 VDC power 74 from the Servo module 12 to bus connectors 40 and 42, so that individual modules on the bus can use local regulators for power at voltages they require.

At least one pin on the Servo module 48-pin DIN connector and on each of the bus connectors 40 and 42 is in some embodiments dedicated to a link 96 to the controller module 36, verifying that all connections are intact before attempting operation. This may be a logic signal connected to, for example, the 24 VDC power supply 72 in the Servo module 12.

Bus assignments for the two 96 pin DIN connectors 40 and 42 in a preferred embodiment include a proprietary parallel expansion bus with address, data, and semaphore signals, an implementation of the Serial Peripheral Interface synchronous serial bus (SPI-bus®) with a specified multimaster protocol, and an implementation of the Controller Area Network serial bus(CANbus®). Alternative bus embodiments may be entirely custom, may be chosen to replicate such recognized standards as VMEbusφ, PCI bus®, PC/104®, and the like, or may combine bus and timing functions from multiple bus standards. Bus designs may require daisy chain connections, such as for handling prioritized interrupts by multiple peripherals.

The functions performed by the Servo module 12, the controller module 36, and the Keypad/Display module 58 in the embodiment shown provide functionality for a servomotor controller product. These functions include power, torque feedback, communication to standard interfaces, and the like. The partition of this embodiment into a processor module, a power driver module, and a display module provides a configuration that is useful, but is not limited to these functions only. It is to be understood that other partitioning concepts can be realized and may be used in some applications.

Additional functions, used in some environments, are provided by separate modules that can be stackably joined to those discussed above. Typical modules for providing additional functions include those shown in FIG. 2, such as a Synchronous Data Link Control (SDLC®) module 98, a Fieldbus® module 100, and a multiple pin input/output (I/O) module 102. Still other module types can be developed, provided a compatible and operational module set can be brought together. At least the module types described below are directly applicable to current usage in industry.

The SDLC module 98 supports a form of Wide Area Network (WAN) that allows, among other capabilities, external control of a servomotor controller 10. In a representative embodiment, multiple controllers 70 connected by SDLC can be controlled by one of their number serving as a master, while the rest are satellites coordinated with that master. This may apply, for example, to a manufacturing fixture in which several nutrunners are set up to operate together in driving a set of fasteners, such as in mounting a cylinder head to an engine block. Each satellite senses the applied torque on its own fastener, but all drive simultaneously using the timing and operational parameters from the master.

The SDLC module 98 may communicate using, for example, IEC Recommended Standard IEC-485 on an input connector 104 and an output connector/termination port 106. The SDLC module 98 may instead use Ethernet®, if preferred. SDLC module addresses can be unique and embedded on an SDLC circuit board 108, dynamically assigned, or set by switches located on the same accessible face of the module 98 as the connectors 104 and 106. The default interface for SDLC under IEC-485 is three shielded twisted pairs supporting a full-duplex, synchronous, multimastering, differential serial bus.

The Fieldbus module 100 is intended for tailoring to a specific application. Many large-scale manufacturers have adopted proprietary communications standards, which in many instances support serial communication with specific physical, data link, and network layer characteristics such as baud rates, media access control (MAC) addresses, handshaking and error detection procedures, and the like. Information passed using a Fieldbus module 100 can include a variety of performance information for statistical analysis and process control, as well as command signals directed to individual servomotor controllers 10. A Fieldbus module 100 may have a single circuit board 110 which, depending on requirements, is manufactured for a specific user, is a generic board with installed firmware, or is a generic board with dedicated FPGA functionality unique to that user. A Fieldbus module 100 may also have additional components besides a single board 110, may have a bus mastering processor 112, or may be a fixed-function satellite. Interface to a Fieldbus module 100 may include features such as indicators 114, switches 116 for configuration selection, and connectors 118 for end-user preferred interfaces. The default interface for Fieldbus is a single shielded twisted pair supporting a multidrop serial bus with a scheduler-arbitrated multimastering protocol.

An I/O module 102 is a multiple port data capture and data output device to manage data elements in an installation, wherein the data elements are not integrated into conventional operational control signals. A controller can in some embodiments benefit from provision of data input 120 and output 122 ports that can accommodate a variety of formats, amplitudes, timing characteristics, and the like. For example, a user may wish to provide, as part of a safety interlock circuit, a nutrunner actuating switch separate from the nutrunner tool 30 itself. An input from such a switch can be sent to an I/O module input 120 and processed by the controller module 36. It is to be understood that more than one I/O module 102 may be needed in an application, so that the module can be provided with an automatic addressing scheme.

An I/O module 102 may, in some embodiments, have a circuit board 124, on which there are conventional port interface components 126 or their FPGA equivalents, to acquire and/or transmit data elements using a specific number of ports. A typical I/O module 102 may be equipped with eight digital inputs and eight digital outputs and provided with connectors 120 and 122 with sufficient pins to support each of the inputs and outputs as a dry contact, moderate current, or other configuration of signal, as suited to each embodiment.

The input and output signal lines in an I/O module 102 may be individually configurable by the controller module 36 through one of the bus interfaces in the stacking 96 pin DIN connectors 40 and 42, or may be configurable in groups of varying sizes, hard-wired with fixed parameters, or otherwise integrated into the servomotor controller 10 system.

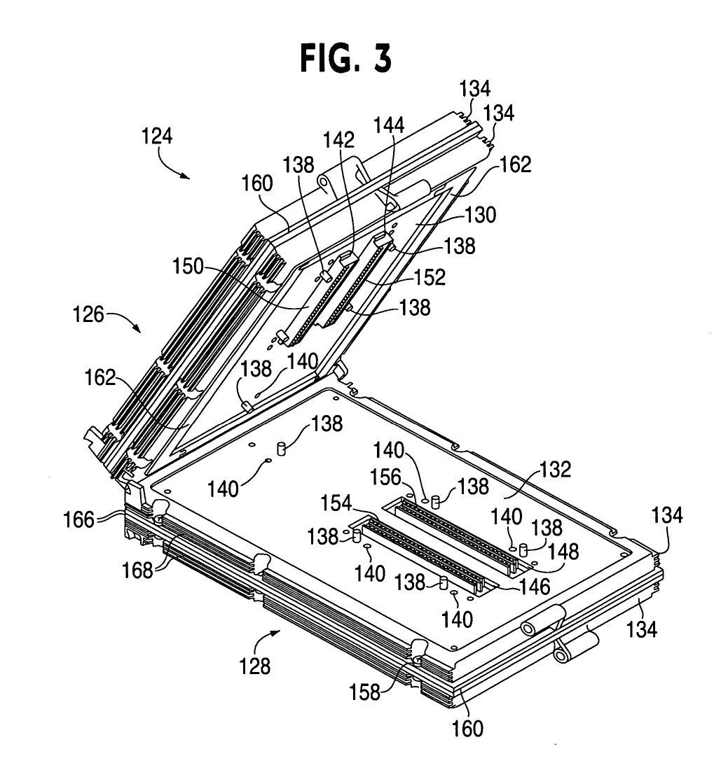

FIG. 3 shows a perspective view 124 of two generic module housings 126 and 128, respectively, hinged open for examination of their mating surfaces 130 and 132, respectively. Each of these housings uses two common-design clamshell-style housing halves 134. Each housing provides enclosure for at least one printed wiring board (PWB) and includes a separate end plate 164 (see FIG. 1) for mounting connectors, lights, switches, and the like. The housing further includes alignment pins 138 and receptacles 140 integral with its structure, which alignment pins 138 and receptacles 140 permit stacking to be accomplished with low position error. The alignment pins 138 in some embodiments protrude beyond the connectors, protecting both the connectors and any electronics contained within the housing.

A housing in the embodiment shown uses a single design of shell half that serves for both top and bottom, because the alignment pin locations are chosen so that the exteriors of two correctly aligned shell halves 134 mate. Top 130 and bottom 132 surfaces include penetrations 142, 144, 146, and 148, respectively, for connector halves 150 and 152 on the top surface 130, which mate with connector halves 154 and 156 on the bottom surface 132. The bottom surface of an controller module 36 requires a variation of the housing penetration arrangement shown in order to provide for the single, smaller connector 34 joining the controller module 36 to the Servo module 12. Similarly, the top housing half of a Keypad/Display module 58 does not need hinges and latches, and requires an arrangement of penetrations suitable to accommodating a selected keypad and display. The top housing half of a typical Keypad/Display module 58 can be sealed with, for example, an adhesive-backed film that allows viewing a display through a transparent window and operating the keypad by deflecting the surface of the film.

Assembly of two housing halves 134 in the embodiment shown uses multiple screws 158 that keep the halves together. Alternative embodiments may be held together by integral detents, rivets, gluing or crimping of the shell halves, or other methods. The embodiment shown captures a PWB between the shell halves. Resilient sealing elements 160 provided between the shell halves seal the modules, while additional sealing elements 162 between modules seal the connector regions, as shown in FIG. 1. The sealing elements 160 provide a so-called drip-proof seal, which resists penetration by water, oils, solvents, and particulates. Downward orientation of the end plate 164 in some embodiments can reduce the requirement for leak resistant connectors.

The embodiment shown further provides continuous mating lips 166 along the sidewalls 168. The lips 166 may include interlocking elements, which elements can, in some embodiments, be of opposite sex on the two sides of each housing half 134 to allow the same design to be used for both halves of a module 126 and 128. The interlocking elements may include pin and socket features, for example, to provide positioning to the resilient sealing elements 160.

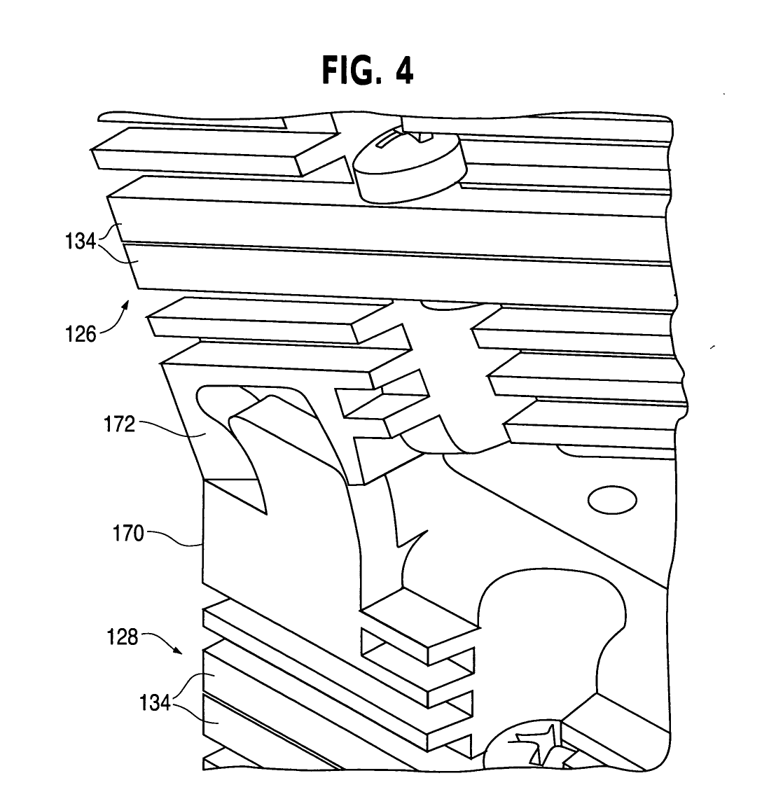

FIGS. 4-6 show elements of the locking connection between adjacent modules 126 and 128, respectively, as provided through a combination of hinging clips and latches. FIG. 4 shows a male hinging clip 170 and a female hinging clip 172, both of which are integral with each housing half 134. FIG. 1 shows one of a mated pair of alternate hinging clips 174 suitable for attachment to an extruded housing such as that of the Servo module 12.

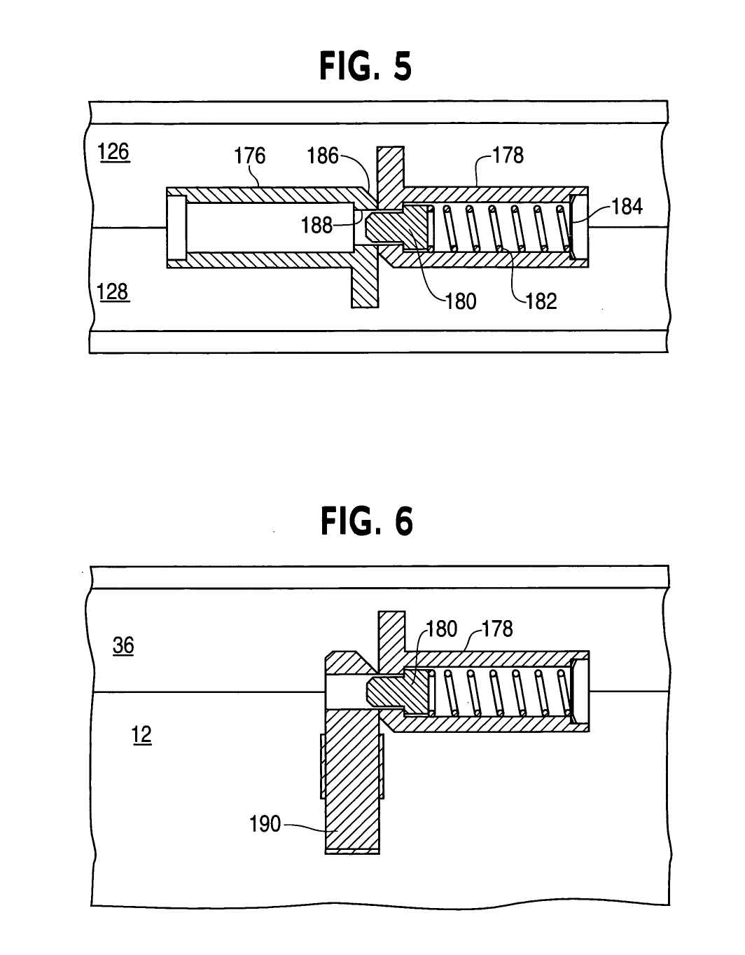

FIG. 5 is a section view showing a latched pair of latch halves 176 and 178, respectively, one of which is integral with each housing half in the modules 126 and 128, respectively. One of the latch halves 178 in each assembled housing module 126 and 128, respectively, includes a detent finger 180 backed by a spring 182 retained by a clip 184. Assembly of adjacent modules 126 and 128 involves fitting the hinging clip halves 170 and 172 together on each side of the modules while keeping the modules spread apart, as shown in FIG. 3, then closing the modules together so that the guide pins 138 and receptacles 140 and the connectors mate. As the modules are being mated, the latch halves 176 and 178 align so that the detent 180 is first retracted by a bevel 186 of the opposite latch half 176, then allowed to spring outward and engage the opposite latch half 176 in a strike 188. Release of the latched elements can be realized in some embodiments by inserting an oblong object of suitable size and rigidity into the latch half 176 far enough to press the detent 180 free of the strike 188.

FIG. 6 is a section view of a latch between a Servo module 12 and an controller module 36, wherein the latch 190 for the Servo module 12 is a separate, attached part rather than an integral component of a module housing.

Typical latching provisions allow stacking of any number of modules, and allow removal and replacement of any module in a stack by releasing a single latch to withdraw the part of the stack including, for example, a module to be removed. Release of that module from the removed portion of the stack then allows reassembly without that module, replacement with another module, or addition of one or more modules.

Some embodiments of the latching provisions according to the invention may require a release tool, such as the oblong object referred to above. Other embodiments may allow toolless disassembly by providing a built-in releasing device.

It may be observed that the latching provision described permits a tool to be inserted above a mounted servomotor controller 10 to release modules, so that a controller 10 can be disassembled and reassembled without removing it from its mount.

The description of the housing herein refers to forming the housing from an unspecified plastic. However, a variety of materials may be suitable for specific embodiments, including particular engineering plastics such as polyethers, polyesters, polystyrenes, copolymers, and the like, which may in some embodiments include fillers such as mica, fibers, or other materials, and which may be mixed or finished with materials supporting static dissipation, electrical conduction, magnetic shielding, or other properties. Forming options include injection molding, comolding of resilient elements, rotary molding, vacuum forming, and the like. The housing may also be cast, drawn, or otherwise formed from metals such as aluminum, zinc, steel, or suitable alloys. Alternative forming options for some metals and plastics include extrusion and impact extrusion.

It is understood that the assembly technique indicated herein, in which each two modules are hooked together at one end using integral fittings, then pivoted sufficiently to align and mate one or more connectors of opposite sexes, the connecting elements of which are largely perpendicular to the largest face of each module, and finally latching the modules together, is one of many equivalent configurations for connecting modules. Others include configuring modules to mate with their large faces essentially parallel during the mating, then attaching the modules together using clips or equivalent holding devices. Another method for mating can use connectors whose mating direction is substantially parallel to the largest face of each module, with the modules first positioned offset, then slid together to mate, and with a suitable clip or latch holding the modules in the assembled configuration. Still another method can use noninserting signal transfer points between modules, such as ball grid array contacts, retracting pins against flat surfaces, fiber optic or transformer coupling, and the like, in which the joining of adjacent modules can use still another process. It is thus anticipated that any attachment method that can provide signal integrity and sufficient electrical power transfer to allow modules to function falls within the scope of the invention.

Although an example of a stackable electronics package is shown configured as a servomotor controller supporting both local controls and multiple remote interfaces, it will be appreciated that other electronically controlled apparatus, such as welders, hoists, robotic positioners, mixers, pumps, materials handlers, materials processors, and numerous other devices, can be realized with such a configuration. Also, although the servomotor controllers described herein are useful to operate handheld and fixture-mounted nut spinners and related assembly tools in the automotive and electronics industries, they can also be used to operate other devices, electric powered or electrically controlled, both closed loop and open loop, and-can be applied in other manufacturing, production, and distribution industries as well as maintenance and service industries.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A modular expandable controller comprising:
a drive module having connectors configured to provide connections to a tool;
a first housing containing at least in part the drive module;
a controller module in communication with the drive module and configured to send a control signal to the drive module; and
a second housing containing at least in part the controller module.

2. The modular expandable controller of claim 1, further comprising:
a user interface module; and
a third housing containing at least in part the user interface module.

3. The modular expandable controller of claim 2, further comprising a keypad user interface in communication with the user interface module.

4. The modular expandable controller of claim 3, further comprising a display in communication with the user interface module.

5. The modular expandable controller of claim 1, further comprising a compatibility module configured to permit the controller to communicate with an external system.

6. The modular expandable controller of claim 1, further comprising an external control module configured to permit the controller to receive and respond to inputs from an external source.

7. The modular expandable controller of claim 1, further comprising an input/output module configured as an electrical interface that can provide at least one electrical signal from the controller to an external device and can accept at least one electrical signal from an external device to the controller.

8. The modular expandable controller of claim 1, further comprising an additional module configured to be attached to the controller and to provide additional functionality to the controller.

9. The modular expandable controller of claim 1, further comprising a mounting bracket for mounting the controller to a wall.

10. The modular expandable controller of claim 1, wherein the modules are electrically and mechanically connected to at least one other module.

11. The modular expandable controller of claim 10, wherein the modules are configured in a stack.

12. The modular expandable controller of claim 10, wherein the housing associated with each module connects to another housing associated with another module in a substantially liquid resistant manner.

13. The modular expandable controller of claim 12, further comprising a gasket located between the housings.

14. The modular expandable controller of claim 10, wherein a housing associated with a module is comprised of a first piece and a second piece substantially identical to the first piece, wherein the first piece has a concave side and a convex side, and wherein the concave side of the first piece and the concave side of the second piece are connected to create a chamber enclosed between the two pieces.

15. The modular expandable controller of claim 10, further comprising:
electrical connectors located on the modules to permit inter-module electrical communication; and
alignment pins located on the housing configured to not allow an electrical connector of one module to mate with an electrical connector of another module unless the alignment pins are aligned with corresponding alignment holes.

16. The modular expandable controller of claim 13, further comprising:
retention fittings located on the modules and configured to permit pivoting inter-module mechanical connection.

17. The modular expandable controller of claim 16, further comprising:
latch fittings located on the modules and configured to interoperate with the retention fittings to provide mechanical linkage between electrically interconnected modules, whereby the modules connect in a substantially liquid resistant manner.

18. A modular expandable controller comprising:
modular driving means having connectors configured to provide connections to a tool;
first housing means containing at least in part the driving means;
modular controlling means in communication with the driving means and configured to send a control signal to the driving means; and
second housing means containing at least in part the controlling means.

19. A method of assembling a modular controller comprising:
configuring a first function performed by a controller, implemented using electronic devices, encased in a first housing to form a module;
configuring a second function performed by a controller, implemented using electronic devices, encased in a second housing to form a module; and
mechanically and electronically connecting the modules together.

20. The method of claim 19, further comprising controlling a tool with the controller.

21. The method of claim 19, further comprising at least one of adding and removing capabilities of the controller by at least one of adding and removing modules to the controller.
